(19) United States
(12) Patent Application Publication
(10) Pub. No.: US 2025/0245138 A1
(43) Pub. Date: Jul. 31, 2025

(54) System and Method for Accessibility Development

(71) Applicant: The Toronto-Dominion Bank, Toronto (CA)

(72) Inventors: Isaac Brendon ROZARIO, Whitby (CA); Vikram Subhash DEVALANKAR, Whitby (CA); Joe HAJJAR, Toronto (CA)

(73) Assignee: The Toronto-Dominion Bank, Toronto, ON (CA)

(21) Appl. No.: 18/427,067

(22) Filed: Jan. 30, 2024

(51) Int. Cl. G06F 11/36; G06F 16/957

(52) U.S. Cl. CPC G06F 11/3698; G06F 11/3688; G06F 16/9574

(57) ABSTRACT

A system, device and method are provided for accessibility testing of digital interfaces. The illustrative method includes providing a digital interface in a browser and receiving input identifying at least one element of the digital interface and a location of the at least one element. Based on the identified at least one element, a dataset of testing is navigated to identify accessibility testing associated with the identified at least one element. The method includes editing at least one predefined routine of the browser to incorporate the identified accessibility testing to the location and implementing the edited at least one predefined routine to test accessibility of the input at least one element.

### TECHNICAL FIELD

The following relates generally to accessibility testing of user interfaces, and more particularly, at least in part, automated accessibility testing.

### BACKGROUND

As various aspects of daily life are digitized, enterprises' ability to develop and maintain accessible digital spaces has at least in part failed. To address the associated shortcomings and given the volume of work involved in making digital interfaces accessible, some existing solutions adopt a one-size-fits-all approach, scanning digital interfaces in their entirety with an automated scanning tool. The existing approaches can include suggesting or implementing remedies to accessibility shortfalls identified by the scan.

Existing approaches, however, can suffer from accuracy issues, can fail to address technical issues that arise when a difference in representation of the accessibility feature in code does not align with the presented visual representation, are undesirably opaque, fail to inform of the potential accessibility concerns in issue, require specialized and expensive expertise to properly implement, rely on automated scanning tools that are responsive to a narrow band of programming approaches or focused only on certain accessibility testing protocols, etc.

In addition, the existing tools can be difficult to control or customize, as they may rely on centralization to enable the automation. For example, existing tools can undesirably rely on definitions provided by a third party to scan web pages, actions, perform validation, etc. The automation and opacity can also make developing expertise to address accessibility issues separate from the centralization difficult. The result is to prevent crowdsourcing of accessibility issues. Any work done remotely can also result in security concerns.

Finally, existing approaches can be unnecessarily duplicative or unresponsive to incremental changes to existing digital interfaces and the process to generate such incremental changes. Some existing approaches may only allow full scanning of the digital interface, resulting in undesirable duplication and delay. Other existing approaches are hard to implement in a typical testing process as developers are unaware of accessibility requirements being applied by the approach to interface elements.

### BRIEF DESCRIPTION OF THE DRAWINGS

Embodiments will now be described with reference to the appended drawings wherein:

FIG. 1 is a schematic diagram of an example computing environment according to the disclosure herein.

FIG. 2 shows an image of an example digital interface according to the disclosure herein.

FIGS. 3A and 3B each show an example image of an example digital interface with overlay elements according to the disclosure herein.

FIGS. 4A, 4B, 4C and 4D show example accessibility parameters in an example interface according to the disclosure herein.

FIG. 5 shows an example digital interface for retrieving accessibility testing parameters according to the disclosure herein.

FIG. 6 shows an example digital interface for performing accessibility testing according to the disclosure herein.

FIG. 7 shows another example digital interface for performing accessibility testing according to the disclosure herein.

FIGS. 8A and 8B show yet another example digital interface for performing accessibility testing according to the disclosure herein.

FIG. 9 shows a block diagram of an example configuration of an enterprise platform according to the disclosure herein.

FIG. 10 shows a block diagram of an example configuration of a device.

FIG. 11 shows a flow diagram of an example method performed by computer executable instructions for accessibility testing.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

This disclosure includes references to accessibility testing or accessibility parameters. It is understood that the term “accessibility” refers to the ease with which a user with some disability can interact with a digital interface. Although accessibility is measured by reference to facilitating access to users with disabilities, implementations responsive to accessibility can benefit users without disabilities. An example of digital interface accessibility criteria is the Web Content Accessibility Guidelines (WCAG).

In one aspect, a device for accessibility testing of digital interfaces is disclosed. The device includes a memory coupled to a processor, the memory storing computer executable instructions that when executed by the processor cause the processor to provide a digital interface in a browser. The memory causes the processor to receive input identifying at least one element of the digital interface and a location of the at least one element, and, based on the identified at least one element, navigate a dataset of testing to identify accessibility testing associated with the identified at least one element. The memory causes the processor to edit at least one predefined routine of the browser to incorporate the identified accessibility testing to the location and implement the edited at least one predefined routine to test accessibility of the input at least one element.

In example embodiments, the instructions cause the processor to in a first instance, implement the at least one predefined routine to generate overlay elements for automatically detected elements; and in a second instance, implement the edited at least one predefined routine to generate additional overlay elements for the identified at least one element.

In example embodiments, the instructions cause the processor to receive a request for accessibility requirements associated with one or more elements of digital user interfaces. The instructions cause the processor to, in response to the request, navigate a dataset of accessibility parameters to identify associated accessibility requirements, the dataset of accessibility parameters including element identities used to navigate the dataset of testing to identify associated (1) accessibility testing, and (2) predefined routines. In example embodiments, the instructions cause the processor to incorporate the identified predefined routines into the browser. In example embodiments, the request identifies element types associated with the one or more elements, and the dataset of accessibility requirements determines associated accessibility requirements based on a comparison between the identified element types and predefined types of elements.

In example embodiments, the at least one predefined routine automatically identifies elements in the digital interface for accessibility testing.

In example embodiments, the at least one predefined routine generates overlay elements that are displayed proximate to elements in the digital interface, and the generated overlay elements indicate the results of accessibility testing. The generated overlay elements can be keyboard navigable. The at least one predefined routine can generate an additional overlay element to remove the overlay elements from the digital interface without refreshing.

In example embodiments, the instructions cause the processor to generate a report based on the result of the edited at least one predefined routine.

In another aspect, a method for accessibility testing of digital interfaces is disclosed. The method includes providing a digital interface in a browser, and receiving input identifying at least one element of the digital interface and a location of the at least one element. Based on the identified at least one element, a dataset of testing is navigated to identify accessibility testing associated with the identified at least one element. The method includes editing at least one predefined routine of the browser to incorporate the identified accessibility testing to the location and implementing the edited at least one predefined routine to test accessibility of the input at least one element.

In example embodiments, the method includes in a first instance, implementing the at least one predefined routine to generate overlay elements for automatically detected elements; and in a second instance, implementing the edited at least one predefined routine to generate additional overlay elements for the identified at least one element.

In example embodiments, the method includes receiving a request for accessibility requirements associated with one or more elements of digital user interfaces. In response to the request, the method includes navigating a dataset of accessibility parameters to identify associated accessibility requirements, the dataset of accessibility parameters including element identities used to navigate the dataset of testing to identify associated (1) accessibility testing, and (2) predefined routines. The identified predefined routines can be incorporated into the browser.

In example embodiments, the request identifies element types associated with the one or more elements, and the dataset of accessibility requirements determines associated accessibility requirements based on a comparison between the identified element types and predefined types of elements.

In example embodiments, the at least one predefined routine generates overlay elements that are displayed proximate to elements in the digital interface, and the generated overlay elements indicate the results of accessibility testing. The generated overlay elements can be keyboard navigable.

In example embodiments, the method includes generating, with the at least one predefined routine, an additional overlay element to remove the overlay elements from the digital interface without refreshing.

In example embodiments, the method includes generating a report based on the result of the edited at least one predefined routine.

In another aspect, a computer readable medium for accessibility testing of digital interfaces is disclosed. The computer readable medium includes computer executable instructions for providing a digital interface in a browser and receiving input identifying at least one element of the digital interface and a location of the at least one element. Based on the identified at least one element, a dataset of testing is navigated to identify accessibility testing associated with the identified at least one element. The computer executable instructions are for editing at least one predefined routine of the browser to incorporate the identified accessibility testing to the location and implementing the edited at least one predefined routine to test accessibility of the input at least one element.

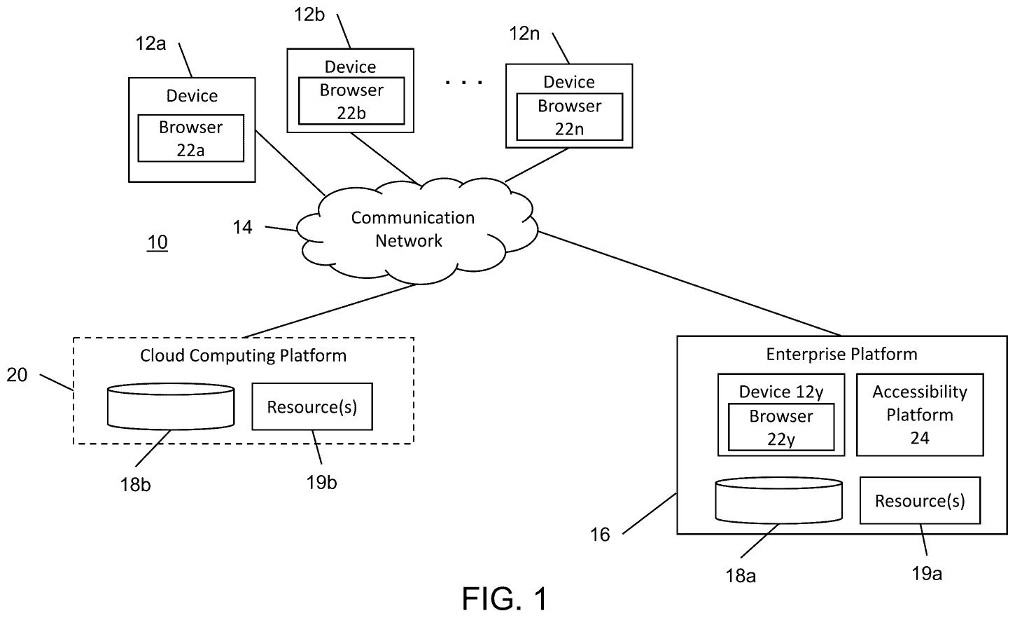

Referring now to FIG. 1, illustrated therein is an example of a computing environment 10. The computing environment 10 can include one or more devices 12 for (directly, or indirectly) performing accessibility testing or for developing more accessible digital interfaces. The environment 10 includes a communications network 14 connecting one or more components of the computing environment 10, an enterprise platform 16, and, optionally, a cloud computing platform 20.

The enterprise platform 16 (e.g., a financial institution such as commercial bank and/or lender) serves data or provides services to users of devices 12. The served data or the provided services (e.g., in the shown embodiment the plurality of enterprise resources 19a and database 18a, or various instances of the shown database 18a, and/or computing resources 19a), can be provided via digital interfaces managed by the enterprise platform 16. In example embodiments, the cloud computing platform 20 can be used to provide one or more instances of data for serving (e.g., via a database 18b), or computing resources to provide enterprise services (e.g., via cloud resources 19b), or provide the digital interfaces used to provide the data or services. Hereinafter, for ease of reference, the resources 18, 19, of the respective platform 16 or 20 shall be referred to generally as resources, unless otherwise indicated.

It can be appreciated that while the cloud computing platform 20 and enterprise platform 16 are shown as separate entities in FIG. 1, they may also be implemented, run, or otherwise directed by a single enterprise. For example, the cloud computing platform 20 can be contracted by the enterprise platform 16 to provide certain functionality of the enterprise platform 16, or the enterprise platform 16 can be almost entirely on the cloud platform 20, etc.

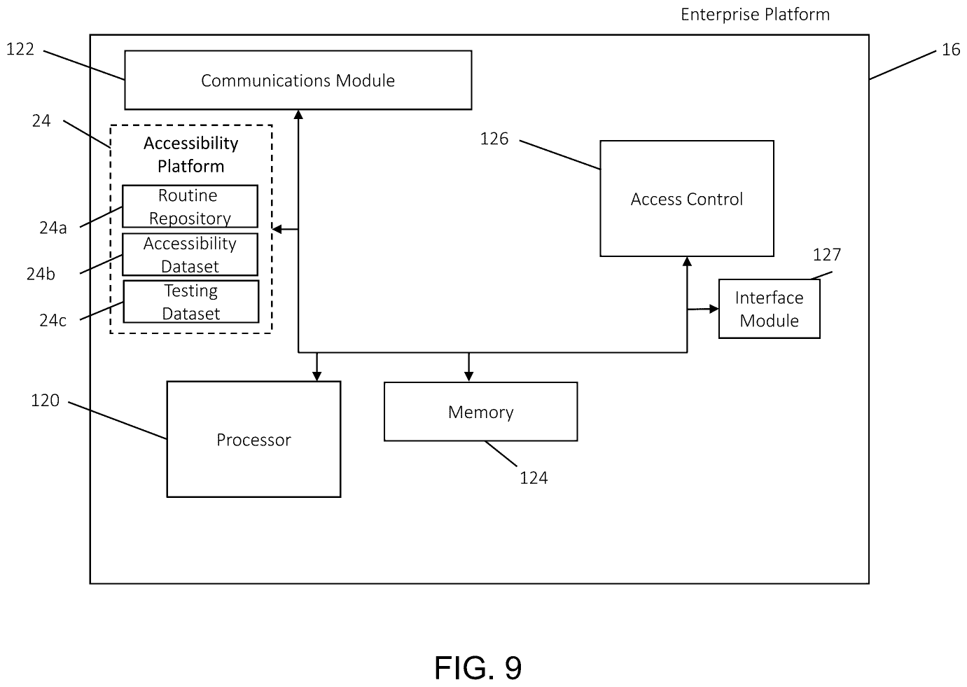

The digital interface used to serve the data or to provide the services can be designed to comply with accessibility parameters. The testing or development process of the resulting digital interface(s) can be based on an accessibility platform 24 which incorporates the accessibility parameters into the design or testing process. While details of the enterprise platform 16 have been omitted for clarity of illustration, reference will be made to FIG. 9 below for additional details.

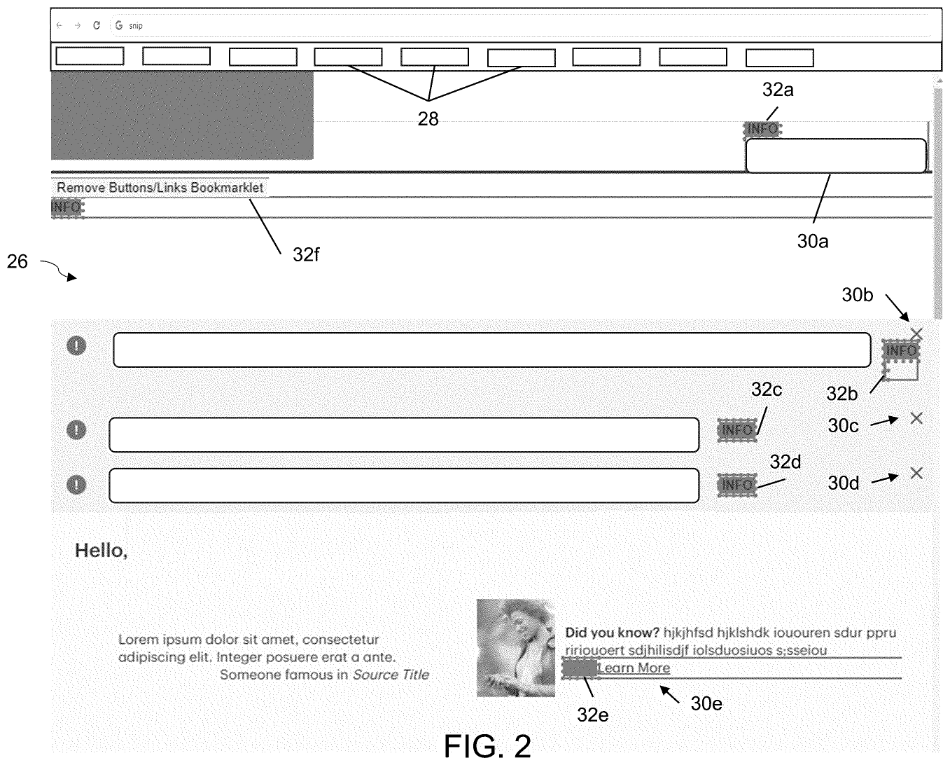

Devices 12 may be associated with one or more users. Users may be referred to herein as customers, clients, users, investors, depositors, correspondents, or other entities that interact with the enterprise platform 16 and/or cloud computing platform 20 (directly or indirectly). The computing environment 10 may include multiple devices 12, each device 12 being associated with a separate user or associated with one or more users. The devices can be external to the enterprise system (e.g., the shown devices 12a, 12b, to 12n, with which clients retrieve sensitive data from the enterprise, or with which employees access the enterprise platform 16 remotely), or internal to the enterprise platform 16 (e.g., the shown device 12x, which can be controlled by a developer or tester of the enterprise). In certain embodiments, a user may operate device 12 such that device 12 performs one or more processes consistent with the disclosed embodiments. For example, the user may use device 12 to develop digital interfaces via access to the cloud computing platform 20, or to test digital interfaces that incorporate data from the database 18a, etc. Each device 12 can have stored thereon, or instantiate a browser 22 (the shown browsers 22a. 22b. 22n, and 22y) to display digital interfaces 26 (FIG. 2).

Devices 12 can include, but are not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 14.

Communication network 14 may include a telephone network, cellular, and/or data communication network to connect different types of devices 12. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), Wi-Fi or other similar wireless network, and a private and/or public wide area network (e.g., the Internet).

FIG. 2 shows an image of an example digital interface 26. The image shows the digital interface 26 provided by a browser (e.g., browser 22) of the device 12. The digital interface 26 includes a plurality of elements 30 (e.g., the shown elements 30a (a button), 30b-30d (close buttons), and 30e (a button/link to more information)) which can be interacted with. The elements 30 can be interacted with via one or more modalities (e.g., text elements can be represented visually or via an auditory feature, etc.). While the shown interface includes a plurality of elements 30, it is understood that the interface 26 can include one or more elements 30.

The browser 22 used to display the digital interface 26 can include one or more predefined routines 28. The routines 28 can be represented or accessed via the browser, including as a bookmark (e.g., as shown in FIG. 2, and alternatively referred to as ‘bookmarklets’). More generally, the routines 28 can be configured to be displayed by the browser alongside any loaded interface 26 to enable crowdsourcing of accessibility testing. The routines 28 can be provided at the time of installation of the browser, added over time, managed by a central authority (e.g., a lead developer, or the enterprise platform 16, directly or indirectly, etc.), periodically updated remotely, etc.

The predefined routines 28 can test or assess accessibility of the loaded digital interface 26. Predefined routines 28 can include routines to test accessibility of different elements 30 (e.g., buttons, lists, tables, etc.) of the interface 26, such as a routine to test all buttons on a given digital interface. More generally, different routines 28 (e.g., represented by different bookmarklets) can be used to implement different tests based on the type(s) of element 30 within the interface 26, content of the interface 26, etc. The predefined routines can include automated detection of elements 30 within the interface 26 that should meet accessibility requirements. For example, a button routine 28 can be configured to parse a web browser document object model (DOM) to identify buttons, and test identified buttons against accessibility requirements associated with the buttons.

The routines 28 can be configured to generate one or more overlay elements 32 to serve alongside the digital interface 26. FIG. 2 shows an example embodiment where a routine 28 that tests button elements 30 in the interface 26 was implemented, and the aforementioned routine 28 generated overlay elements 32a-32e for detected buttons. The overlay elements 32 of FIG. 2 indicate or serve results of the accessibility testing carried out by the routine 28, and are positioned proximate to the respective element 30 tested. The routine 28 can be edited to ensure that generated overlay elements 32 are navigable by keyboard, as in example embodiments the users that test interfaces 26 for accessibility themselves require accessible testing solutions.

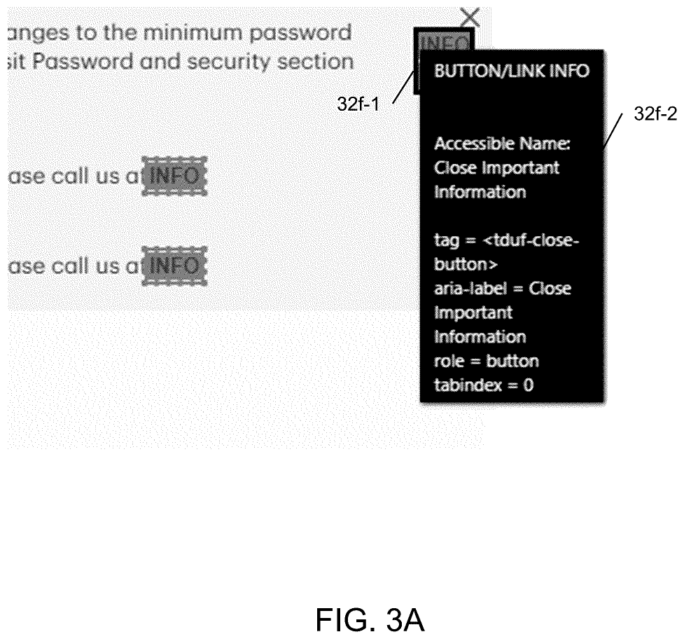

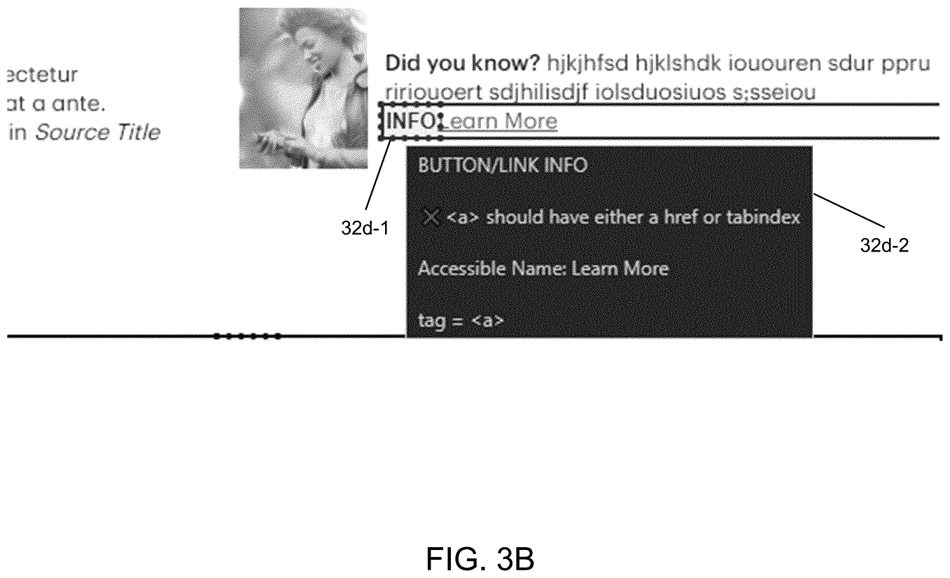

The overlay elements 32 can be layered, showing more or less information based on user interaction. For example, in the embodiments shown in FIGS. 3A and 3B, the overlay element 32d-1, 32f-1 is used to indicate that accessibility testing data is available, and an additional overlay element 32d-2, 32f-2 is used to provide the testing results upon user interaction. Overlay element 32f-2 shows an example of information included that indicates that the element 30e is not compliant. Overlay elements 32d-2, 32f-2 can also show more detailed information about the types of tests implemented, and additional information to facilitate aria (or html5) capabilities.

The routines 28 can be configured to generate an overlay element 32f to remove the other generated overlay elements 32. In this way, the user of device 12 can perform various routines 28 without visually cluttering the interface 26 through successive routines and without requiring time consuming and thought disrupting refreshing of the interface 26.

In example embodiments, the routine 28 can be configured to generate and send a report indicating the status of the interface 26. For example, the enterprise employee responsible for accessibility can be provided with periodic reports indicating a progress of retrofitting existing interfaces 26 to meet accessibility requirements. In at least some example embodiments, the routine 28 can be configured or later edited to perform remediation for identified accessibility issues. For example, the routine 28 can be configured with predefined corrections, or a user can use a template from the testing database (as described herein) to employ bespoke automated corrections.

In existing solutions, the automated detection of elements can be inaccurate, for example by overlooking poorly programmed elements. For example, a representation of an accessibility feature in code may not align with the visual representation. While the difference can be spotted by a reviewer, existing automated scanning tools fail to appreciate the difference. Alternatively stated, automated scanning tools can have trouble accurately identifying all elements within a digital interface. As a result, one aspect of this disclosure includes accessibility testing that integrated with automated testing to capture errors in automated testing.

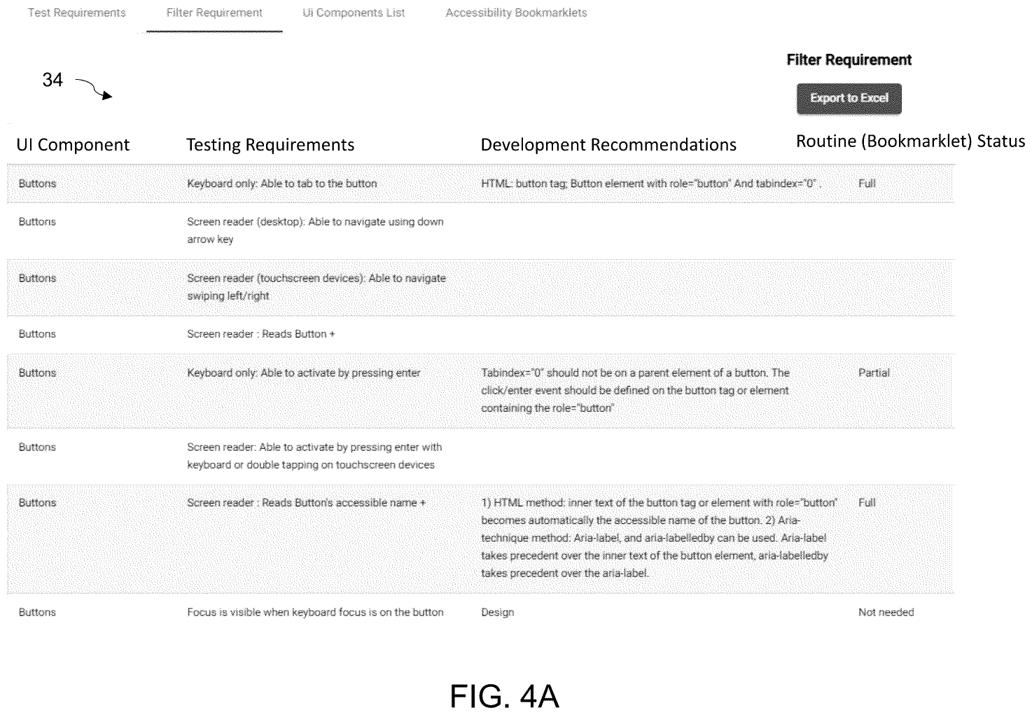

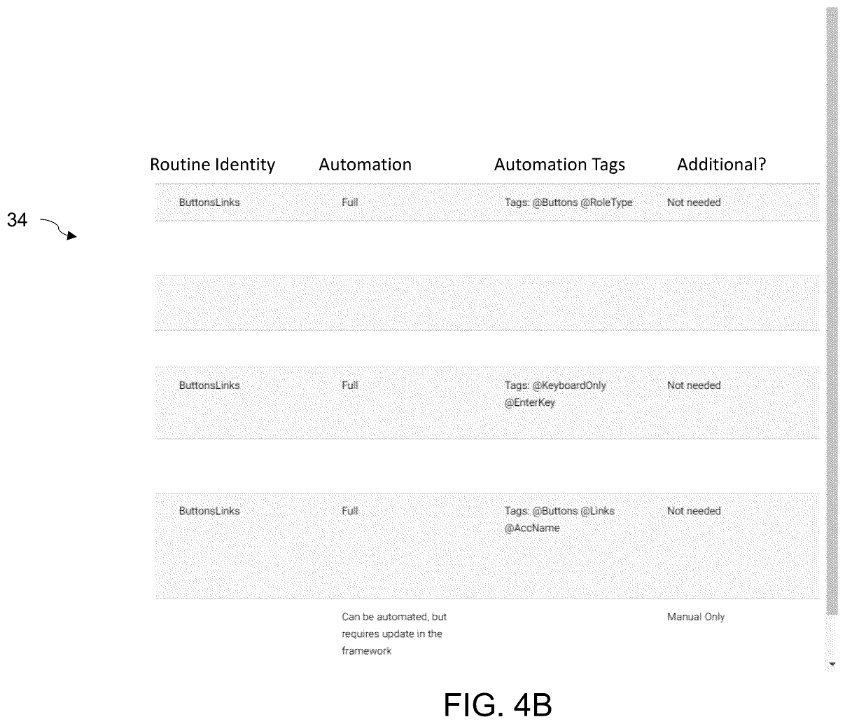

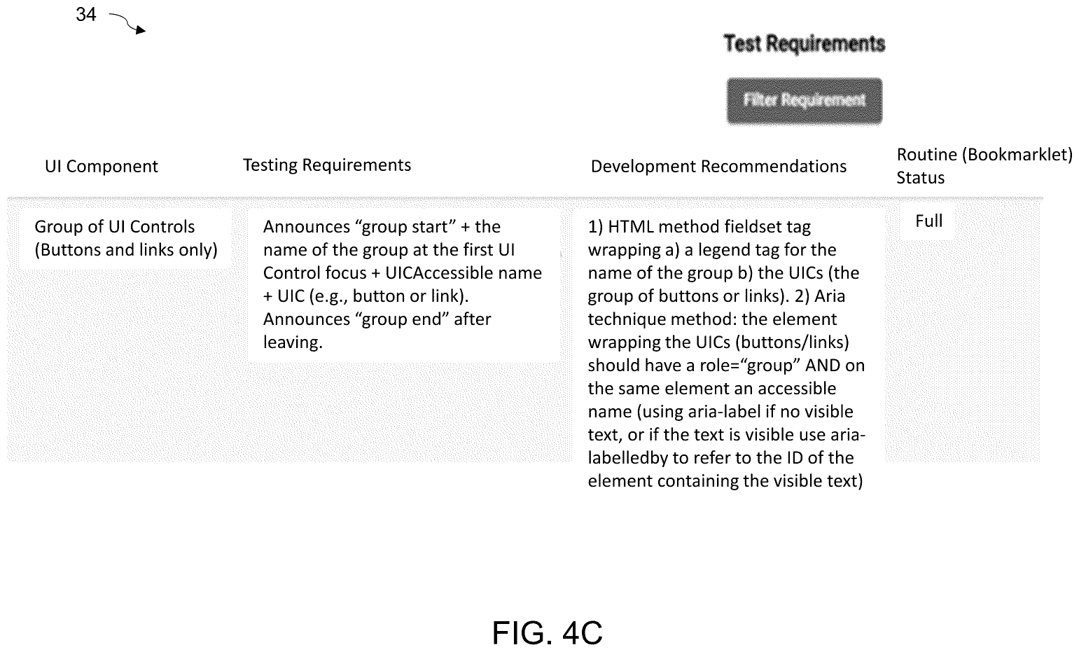

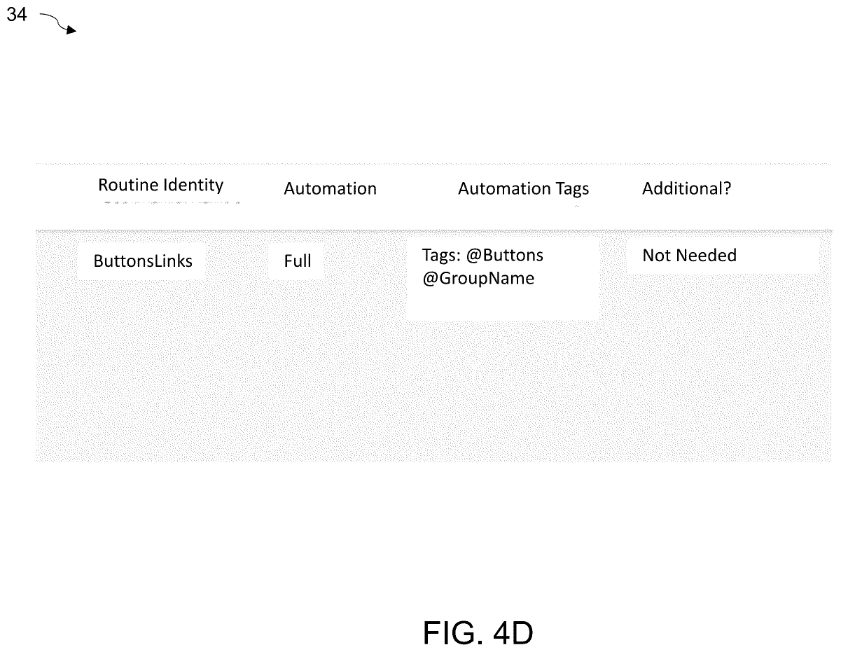

FIGS. 4A, 4B, 4C and 4D show an example of a dataset 34 (referred to in the alternative as a “dataset of accessibility parameters”) that can be used to implement functionality to test elements for accessibility, where the elements are missed or improperly handled by automated solutions. More specifically, FIGS. 4A (left component) and 4B (right component) are components of the same entries, and FIGS. 4C (left component) and 4D (right component) are components of the same entries.

The datasets shown in FIGS. 4A, 4B, 4C and 4D can include a variety of accessibility parameters. In at least some example embodiments, including the shown embodiments, the accessibility parameters are organized according to the type of element 30 of the interface 26. For example, in FIGS. 4A and 4B, button element 30 accessibility parameters are displayed, including the testing requirements (which can be used by developers to understand how to configure button elements so that they can pass testing), development recommendations to help developers generate compliant elements 30, whether the routine can be used for validation, a routine identity relevant to the accessibility parameters, whether the associated automation can be used for validation, automation identifiers for accessibility parameter, and additional information that can be helpful for development or testing teams (e.g., whether manual testing is required).

The automation identifiers can identify the relevant test dataset or testing dataset portion (as discussed herein), while the routine identity portion of the shown dataset can be used to identify a routine 28 which can be used to implement the relevant test of the testing dataset.

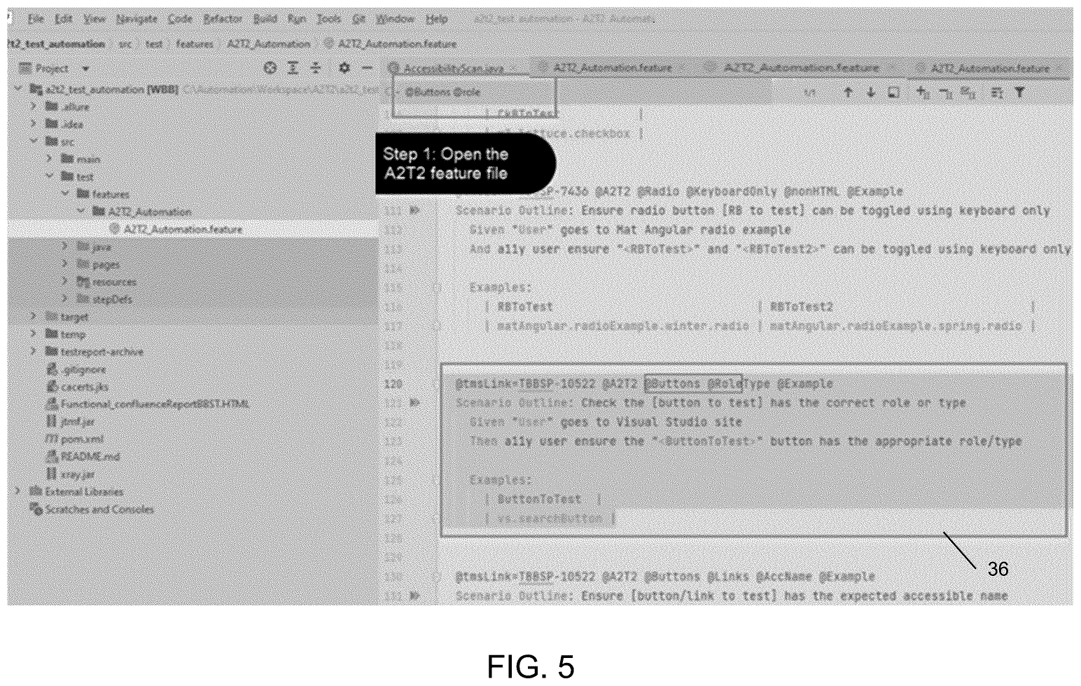

A testing dataset can be a dataset maintained by the enterprise in control of the enterprise platform 16, or a third party, or any party, that includes accessibility testing scenarios. For example, FIG. 5 is an image of an example digital interface for retrieving accessibility testing parameters. As shown in FIG. 5, the testing dataset is accessed (the shown step 1), and then the dataset is searched for the earlier identified automation identifiers (or tags). The testing dataset is navigated to responsive testing scripts (e.g., the shown script 36). The scripts or portions of the testing datasets can require additional input to operate on elements that were not correctly assessed with automated tools. For example, in this shown embodiment, the shown script 36 requires the location of a button (e.g., an html link) to test the button. The testing database and the accessibility parameter dataset can evolve over time, the testing dataset be supplemented over time to include scripts responsive to scenarios that are commonly missed through automation, to respond to common errors, etc. The accessibility parameter dataset can be updated to include the latest best practice for developers, to notify developers of new accessibility testing that will be applied to different elements, etc. In at least some example embodiments, the testing and accessibility datasets are different aspects of the same dataset.

Allowing a user to supplement, or actively testing desired elements (e.g., via locations of elements) with desired accessibility testing tools within a testing dataset can potentially allow for more accurate testing as a whole, democratize testing given that the process can be implemented by other than experts in accessibility testing, can adapt to changing circumstances and implementation strategies, and/or reduce duplication and expense associated with third party solutions.

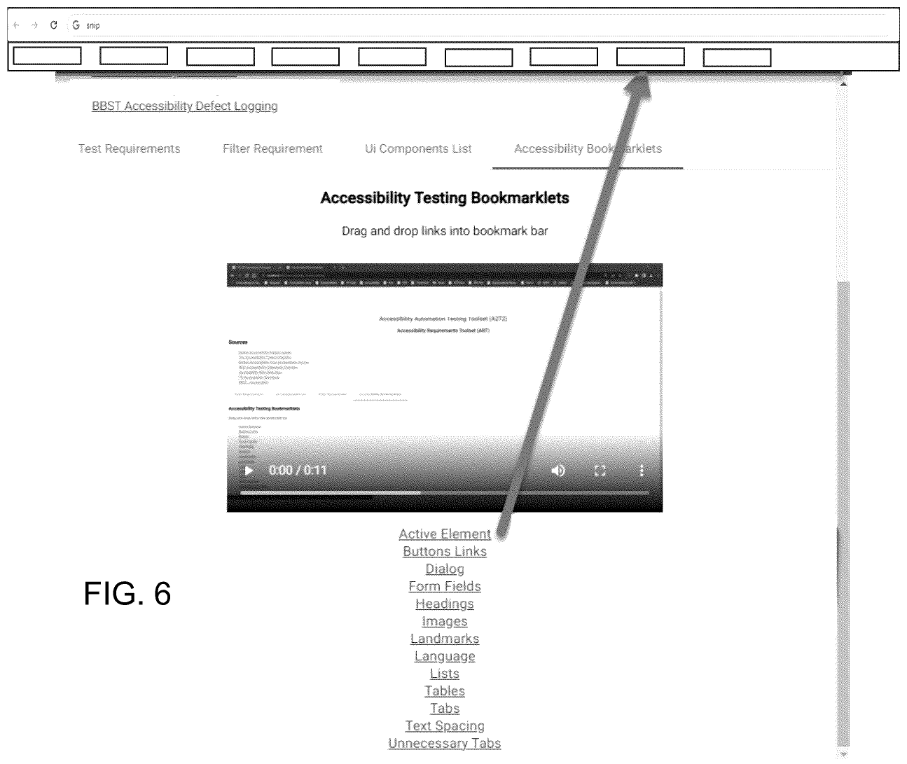

In example embodiments, an accessibility platform 24 (which, while shown as a single platform, can be various instances distributed throughout the enterprise platform 16) of routines 28 and testing and accessibility parameter databases can be maintained by the enterprise. For example, FIG. 6 shows a web page for the accessibility platform 24, hosted by the enterprise that enables devices 12, to add routines 28 to their browsers (e.g., via the shown drag and drop method).

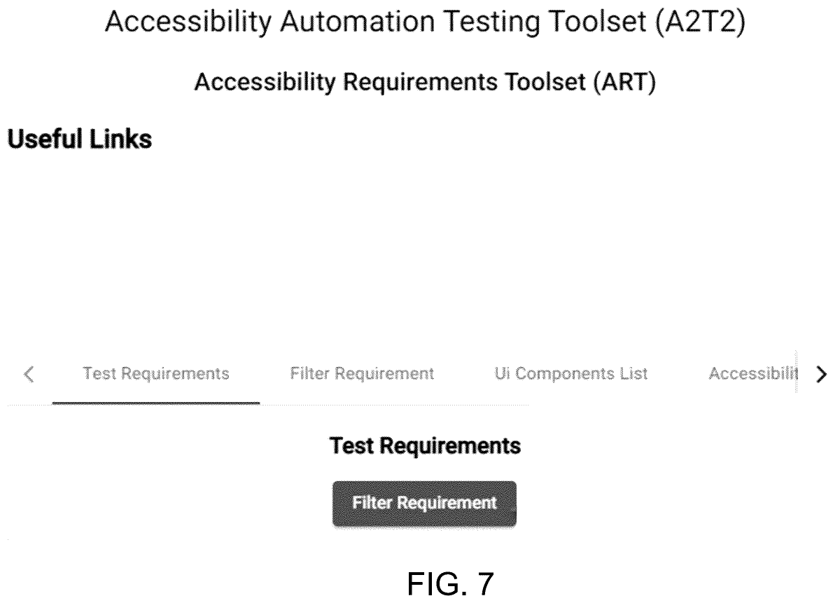

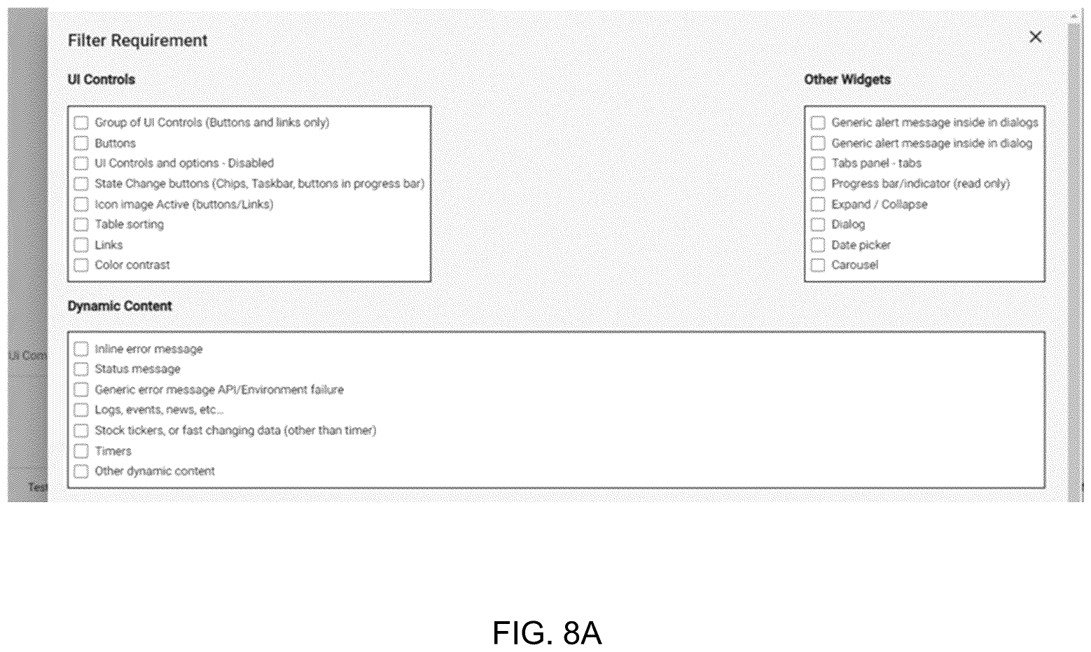

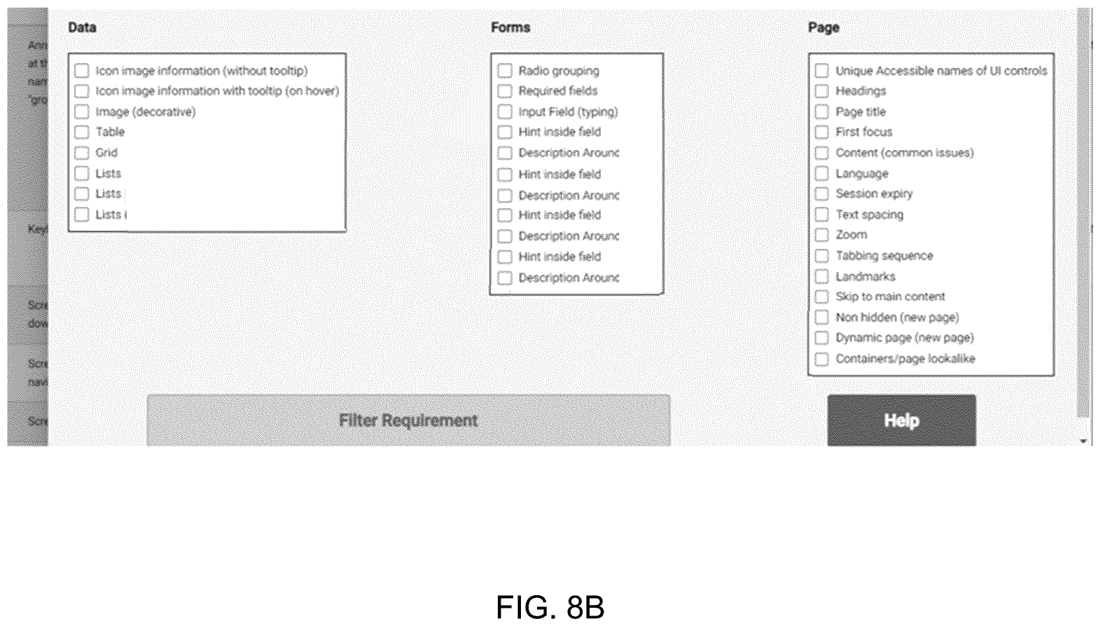

Another aspect of the accessibility platform 24 can include a testing requirement filter to enable developers or testers to identify relevant testing metrics for their interface 26. For example, if a developer wishes to generate a digital interface 26 for the enterprise, FIG. 7 shows a landing page for filtering testing requirements according to element types of the proposed interface 26. FIGS. 8A and 8B show a checklist that can be used by the developer to catalogue elements 30 in the proposed interface 26, and the accessibility platform 24 can provide datasets (accessibility or testing) responsive to the identified elements, such as the datasets shown in FIG. 4.

Referring now to FIG. 9, a block diagram of an example configuration of enterprise platform 16 is shown. FIG. 9 illustrates examples of modules, tools and engines stored in memory 124 on the enterprise platform 16 and operated or executed by the processor 120. It can be appreciated that any of the modules, tools, and engines shown in FIG. 9 may also be hosted externally and be available via the cloud computing platform 20, e.g., via the communications module 122.

In the example embodiment shown in FIG. 9, the enterprise platform 16 includes an access control module 126, a device interface module 127 for interacting with devices, or databases, or cloud resources, etc. The access control module 126 may be used to apply a hierarchy of permission levels or otherwise apply predetermined criteria to determine what aspects of the accessibility platform 24 can be accessed by devices 12, what resources 18b, 19b, the platform 20 can provide access to, etc. For example, the cloud computing platform 20 may grant certain employees of the enterprise platform 16 access to only certain resources 18b, 19b, but not other resources. In another example, the access control module 126 can be used to control which users are permitted to alter routine repositories 24a of the accessibility platform (which controls which routines 28 are pushed by the enterprise, for example), or accessibility dataset repository 24b of the platform 24, or testing dataset repository 24c of the platform 24, etc. As such, the access control module 126 can be used to control the sharing of resources 18b, 19b, the dissemination of enterprise standards and know-how, etc., based on the sensitivity of the interface 26, a permission or preference, or any other restriction imposed by the enterprise platform 16, the computing environment 10, or application in which the cloud computing platform 20 is used.

The interface module 127 can provide a graphical user interface (GUI), software development kit (SDK) or application programming interface (API) connectivity to communicate with devices 12 or other components of the environment 10. It can be appreciated that the interface module 127 may also provide a web browser-based interface, an application or “app” interface, a machine language interface, etc. The enterprise platform 16 may include a database interface module (not shown) for interfacing with the remote or local datastores to retrieve, modify, and store (e.g., add) data to the resources 18a, 19a.

Communications module 122 enables the enterprise platform 16 to communicate with one or more other components of the computing environment 10, such as the cloud computing platform 20 (or one of its components), via a bus or other communication network, such as the communication network 14. The enterprise platform 16 can include at least one memory or memory device 124 that can include a tangible and non-transitory computer-readable medium having stored therein computer programs, sets of instructions, code, or data to be executed by processor 120. FIG. 4 illustrates examples of platforms (e.g., platform 24), modules, tools and engines stored in memory on the enterprise platform 16 and operated or executed by the processor 120. It can be appreciated that any of the modules, tools, and engines shown in FIG. 4 may also be hosted externally and be available to the enterprise platform 16, e.g., via the communications module 122.

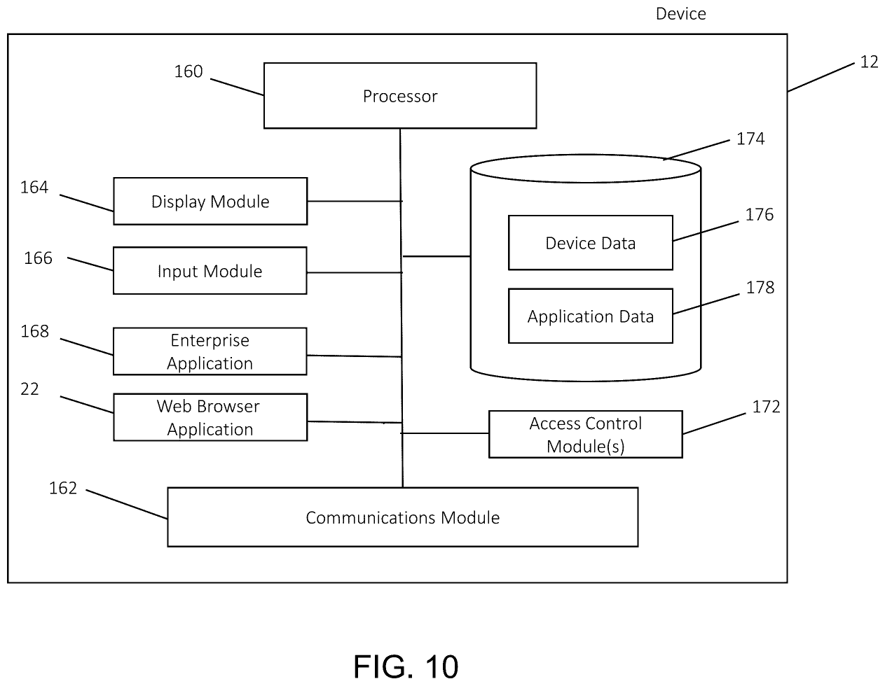

In FIG. 10, an example configuration of a device 12 is shown. In certain embodiments, the device 12 may include one or more processors 160, a communications module 162, and a data store 174 storing device data 176 (e.g., the routines 28), an access control module 172 similar to the access control module of FIG. 9, and application data 178 (e.g., data to enable communicating with the enterprise platform 16, or browser data, etc.). Communications module 162 enables the device 12 to communicate with one or more other components of the computing environment 10, such as cloud computing platform 20, or enterprise platform 16, via a bus or other communication network, such as the communication network 14. While not delineated in FIG. 10, similar to the enterprise platform 16 the device 12 includes at least one memory or memory device that can include a tangible and non-transitory computer-readable medium having stored therein computer programs, sets of instructions, code, or data to be executed by processor 160. FIG. 10 illustrates examples of modules and applications stored in memory on the device 12 and operated by the processor 160. It can be appreciated that any of the modules and applications shown in FIG. 10 may also be hosted externally and be available to the device 12, e.g., via the communications module 162.

In the example embodiment shown in FIG. 10, the device 12 includes a display module 164 for rendering digital interfaces and other visual outputs on a display device such as a display screen, and an input module 166 for processing user or other inputs received at the device 12, e.g., via a touchscreen, input button, transceiver, microphone, keyboard, etc. The device 12 may also include an enterprise application 168 provided by the enterprise platform 16, e.g., for authenticating with the enterprise platform 16. The device 12 in this example embodiment also includes a web browser application 22 for accessing Internet-based content, e.g., via a mobile or traditional website offered by the enterprise platform 16, a third party, or the cloud computing platform 20. The data store 174 may be used to store device data 176, such as, but not limited to, an IP address or a MAC address that uniquely identifies device 12 within environment 10. The data store 176 may also be used to store authentication data, such as, but not limited to, login credentials, user preferences, cryptographic data (e.g., cryptographic keys), etc.

It will be appreciated that only certain modules, applications, tools, and engines are shown in FIGS. 9 and 10 for ease of illustration and various other components would be provided and utilized by the enterprise platform 16, and device 12, as is known in the art.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of any of the servers or other devices in cloud computing platform 20 or enterprise platform 16, or device 12, or accessible or connectable thereto. Any application or module herein described may be implemented using computer readable/executable instructions that may be stored or otherwise held by such computer readable media.

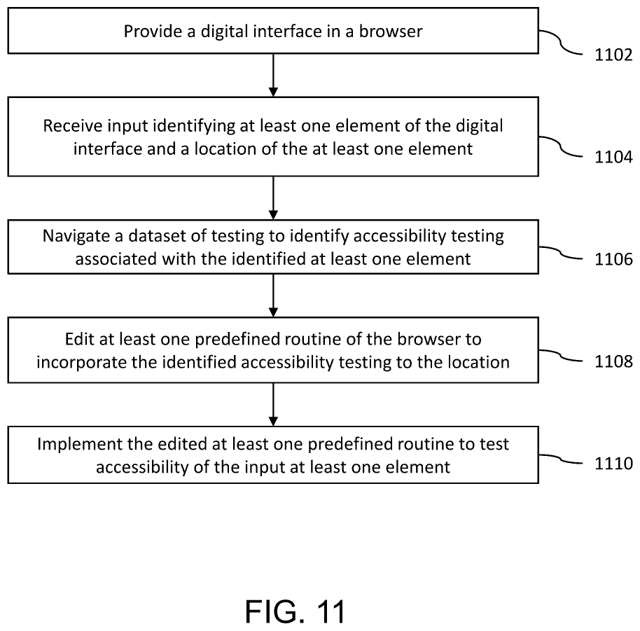

Referring to FIG. 11, a flow diagram of an example method performed by computer executable instructions for accessibility testing of digital interfaces is shown. It is understood that FIG. 11 is described by way of reference to the preceding figures, but that such reference to the preceding figures is illustrative only, and not intended to be limiting.

At block 1102, a digital interface such as interface 26 is provided in a browser 22.

At block 1104, an input is received. The input identifies at least one element (e.g., element 30) of the digital interface. Identifying an element can include identifying the type of the element. Identifying the element can include identifying content in the element, or other parameters as shown in FIGS. 8A and 8B. The input of block 1104 can also include a location of the identified element.

At block 1106, based on the identified at least one element, a dataset of testing (e.g., the dataset shown in FIG. 5) is navigated to identify accessibility testing associated with the identified at least one element. Navigating the dataset can include searching the accessibility dataset for automation identifiers relevant to the identified element.

At block 1108, at least one predefined routine (e.g., routine 28) of the browser is edited to incorporate the identified accessibility testing to the identified element (e.g., via the location).

At block 1110, the edited at least one predefined routine is implemented to test accessibility of the input at least one element.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A device for accessibility testing of digital interfaces, the device comprising:
a memory coupled to a processor, the memory storing computer executable instructions that when executed by the processor cause the processor to:
provide a digital interface in a browser;
receive input identifying at least one element of the digital interface and a location of the identified at least one element;
based on the identified at least one element, navigate a dataset of testing to identify accessibility testing associated with the identified at least one element;
edit at least one predefined routine of the browser to incorporate the identified accessibility testing to the location; and
implement the edited at least one predefined routine to test accessibility of the input at least one element.

2. The device of claim 1, wherein the instructions cause the processor to:
in a first instance, implement the at least one predefined routine to generate overlay elements for automatically detected elements; and
in a second instance, implement the edited at least one predefined routine to generate additional overlay elements for the identified at least one element.

3. The device of claim 1, wherein the instructions cause the processor to:
receive a request for accessibility requirements associated with one or more elements of digital user interfaces; and
in response to the request, navigate a dataset of accessibility parameters to identify associated accessibility requirements, the dataset of accessibility parameters including element identities used to navigate the dataset of testing to identify associated (1) accessibility testing, and (2) predefined routines.

4. The device of claim 3, wherein the instructions cause the processor to:
incorporate the identified predefined routines into the browser.

5. The device of claim 3, wherein the request identifies element types associated with the one or more elements, and the dataset of accessibility requirements determines associated accessibility requirements based on a comparison between the identified element types and predefined types of elements.

6. The device of claim 1, wherein the at least one predefined routine automatically identifies elements in the digital interface for accessibility testing.

7. The device of claim 1, wherein the at least one predefined routine generates overlay elements that are displayed proximate to elements in the digital interface, and the generated overlay elements indicate results of accessibility testing.

8. The device of claim 7, wherein the generated overlay elements are keyboard navigable.

9. The device of claim 7, wherein the at least one predefined routine generates an additional overlay element to remove the overlay elements from the digital interface without refreshing.

10. The device of claim 1, wherein the instructions cause the processor to:
generate a report based on a result of the edited at least one predefined routine.

11. A method for accessibility testing of digital interfaces, the method comprising:
providing a digital interface in a browser;
receiving input identifying at least one element of the digital interface and a location of the identified at least one element;
based on the identified at least one element, navigating a dataset of testing to identify accessibility testing associated with the identified at least one element;
editing at least one predefined routine of the browser to incorporate the identified accessibility testing to the location; and
implementing the edited at least one predefined routine to test accessibility of the input at least one element.

12. The method of claim 11, comprising:
in a first instance, implementing the at least one predefined routine to generate overlay elements for automatically detected elements; and
in a second instance, implementing the edited at least one predefined routine to generate additional overlay elements for the identified at least one element.

13. The method of claim 11, further comprising:
receiving a request for accessibility requirements associated with one or more elements of digital user interfaces; and
in response to the request, navigating a dataset of accessibility parameters to identify associated accessibility requirements, the dataset of accessibility parameters including element identities used to navigate the dataset of testing to identify associated (1) accessibility testing, and (2) predefined routines.

14. The method of claim 13, comprising:
incorporating the identified predefined routines into the browser.

15. The method of claim 13, wherein the request identifies element types associated with the one or more elements, and the dataset of accessibility requirements determines associated accessibility requirements based on a comparison between the identified element types and predefined types of elements.

16. The method of claim 11, wherein the at least one predefined routine generates overlay elements that are displayed proximate to elements in the digital interface, and the generated overlay elements indicate the results of accessibility testing.

17. The method of claim 16, wherein the generated overlay elements are keyboard navigable.

18. The method of claim 16, comprising:
generating, with the at least one predefined routine, an additional overlay element to remove the overlay elements from the digital interface without refreshing.

19. The method of claim 11, comprising:
generating a report based on the result of the edited at least one predefined routine.

20. A non-transitory computer readable medium for accessibility testing of digital interfaces, the computer readable medium comprising computer executable instructions for:
providing a digital interface in a browser;
receiving input identifying at least one element of the digital interface and a location of identified the at least one element;
based on the identified at least one element, navigating a dataset of testing to identify accessibility testing associated with the identified at least one element;
editing at least one predefined routine of the browser to incorporate the identified accessibility testing to the location; and
implementing the edited at least one predefined routine to test accessibility of the input at least one element.
